(19) United States
(12) Patent Application Publication
(10) Pub. No.: US 2005/0190149 A1
(43) Pub. Date: Sep. 1, 2005

(54) User interface using geomagnetic sensor and method of generating input signal thereof

(75) Inventors: Woo-jong Lee, Suwon-si (KR); Sang-on Choi, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/052,750

(22) Filed: Feb. 9, 2005

(30) Foreign Application Priority Data
Feb. 9, 2004 (KR) 2004-08394

(51) Int. Cl. G09G 5/00

(52) U.S. Cl. 345/156

(57) ABSTRACT

A user interface using a geomagnetic sensor and a method of generating an input signal thereof which can generate an input signal by calculating position coordinates of a pointer using output values of the geomagnetic sensor according to a inclining degree of the user interface. The user interface includes a geomagnetic sensor for digitalizing and outputting voltage values of X and Y axes of the geomagnetic sensor, which are induced by a geomagnetic field and correspond to an inclining state of the user interface, with predetermined levels, a memory for storing the output values of the geomagnetic sensor, present coordinates of a pointer, and center coordinates of a screen of a display device, and a controller for controlling the output levels of the geomagnetic sensor, calculating new coordinates of the pointer corresponding to the inclining state using the output values of the X and Y axes, and outputting a signal corresponding to information about the new coordinates of the pointer to the display device.

This application claims benefit under 35 U.S.C. § 119 from Korean Patent Application No. 2004-8394, filed on Feb. 9, 2004, the entire content of which is incorporated herein by reference.

### BACKGROUND OF THE INVENTION

1. Field of the Invention

The present invention relates to a user interface using a geomagnetic sensor and a method of generating an input signal thereof which generates an input signal for moving a position of a pointer on a screen of a display device in accordance with a user's request. More particularly, the present invention relates to a user interface using a geomagnetic sensor and a method of generating an input signal thereof which calculates position coordinates of a pointer corresponding to an inclining direction and an inclining degree of a user interface using output values of X and Y axes of the geomagnetic sensor, and outputs the calculated pointer position coordinates as the input signal.

2. Description of the Related Art

Recently, with the development of electronic technology and network communication technology, diverse electronic appliances such as cellular phones, PDAs, notebook computers, and so on, have widely been popularized. Recent electronic appliances generally have diverse functions such as game, text service, memo pad, etc., and a user can use such functions through input means provided in the appliances. Portable electronic appliances, however, are subject to hardware restrictions in that they cannot have diverse input means such as a mouse, joystick, keyboard, etc., which are provided in a PC or other game machines.

In order to overcome such hardware restrictions, a touch screen has widely been used as an input means. The touch screen, as shown in FIG. 1, includes a piezoelectric layer 10 for X coordinates, a spacer 20 and a piezoelectric layer 30 for Y coordinates, and lines of sensors, which react to pressures applied to a screen surface, are closely arranged on the piezoelectric layer 10 for X coordinates and the piezoelectric layer 30 for Y coordinates, so that a position of the screen, to which the pressure is applied, is recognized as its coordinates. This touch screen type user interface is designed to recognize a part of the screen that is touched by a finger or a touch pen in a form of a ball-point pen, so as to execute a corresponding command, or to move a cursor on the screen.

Although the touch screen type user interface has widely been used, it has a disadvantage that its accuracy is somewhat limited. Also, the touch screen type user interface requires hardware such as a substrate for sensing pressures and an analog-to-digital converter, and deteriorates the brightness of a display window.

### SUMMARY OF THE INVENTION

The present invention has been developed in order to solve the above drawbacks and other problems associated with the conventional arrangement. An aspect of the present invention is to provide a user interface using a geomagnetic sensor and a method of generating an input signal thereof which calculates position coordinates of a pointer using output values of X and Y axes of the geomagnetic sensor according to an inclining degree of the user interface, and outputs the calculated pointer position coordinates as the input signal.

The foregoing and other objects and advantages are substantially realized by providing a user interface using a geomagnetic sensor which generates an input signal for moving a pointer to a certain position on a screen of a display device in accordance with a user's request, according to the present invention, which comprises a geomagnetic sensor for digitalizing and outputting voltage values of X and Y axes, which are induced by a geomagnetic field and correspond to an inclining state of the user interface, with predetermined levels, a memory for storing the output values of the geomagnetic sensor, present coordinates of the pointer, and center coordinates of the screen, and a controller for controlling the output levels of the geomagnetic sensor, calculating new coordinates of the pointer corresponding to the inclining state using the output values of the X and Y axes, and outputting a signal corresponding to information about the new coordinates of the pointer to the display device.

Here, it is preferable that the output values of the X and Y axes of the geomagnetic sensor are integers.

It is preferable that when the geomagnetic sensor is rotated in a horizontal state, the controller calculates bias values defined as average values of maximum values and minimum values of the output values of the X and Y axes, respectively, and stores the calculated bias values in the memory. Preferably, the bias values correspond to the center coordinates of the screen. [10

Meanwhile, the new coordinates (mx, my) of the pointer may be calculated using a following equation:
mx=cx+nx−fx_bias
my=cy+ny
fy_bias
where, cx and cy denote the center coordinates (cx, cy) of the screen, nx and ny denote the output values of the X and Y axes of the geomagnetic sensor, and fx_bias and fy_bias denote the bias values.

Preferably, the controller outputs the signal corresponding to the information about the new coordinates of the pointer to the display device, and updates the present coordinates to the new coordinates.

The geomagnetic sensor comprises a drive signal generating unit for generating a drive pulse signal and generating a voltage according to the drive pulse signal, a biaxial flux gate for receiving the voltage and outputting voltage values corresponding to analog signals for the X and Y axes in accordance with the geomagnetic field, and a signal processing unit for amplifying the voltage values and converting the amplified voltage values into digital values.

In another aspect of the present invention, there is provided a method of generating an input signal of a user interface using a geomagnetic sensor for controlling a position of a pointer on a screen of a display device in accordance with a user's request, according to the present invention, which comprises the steps of (a) storing center coordinates of the screen in a memory, (b) rotating the user interface in a horizontal state, calculating bias values defined as average values of maximum values and minimum values of the output values of the X and Y axes of the geomagnetic sensor, and storing the calculated bias values in the memory, (c) measuring the output values of the X and Y axes corresponding to an inclining state of the user interface, and (d) calculating new coordinates of the pointer corresponding to the inclining state of the user interface using the output values of the X and Y axes.

The method of generating the input signal may further comprise the step (e) of outputting a signal corresponding to information about the new coordinates of the pointer to the display device.

Preferably, the output values of the geomagnetic sensor are integers, and the bias values are controlled so as to correspond the center coordinates of the screen.

Meanwhile, the new coordinates of the pointer may be calculated using the above-described equation.

### BRIEF DESCRIPTION OF THE DRAWINGS

The above aspects and features of the present invention will be more apparent by describing certain embodiments of the present invention with reference to the accompanying drawings, in which:

FIG. 1 is a view explaining a conventional touch screen type user interface;

FIG. 2 is a block diagram illustrating the construction of a user interface using a geomagnetic sensor according to the present invention;

FIGS. 3A is a view illustrating an X-axis output value and a Y-axis output value obtained when the user interface is rotated in a horizontal state according to the present invention;

FIG. 3B is a view illustrating a cursor positioned at the center coordinates of a screen of a display device which correspond to the bias values as illustrated in FIG. 3A according to the present invention; and

FIG. 4 is a flowchart illustrating a method of generating an input signal of a user interface using a geomagnetic sensor according to the present invention.

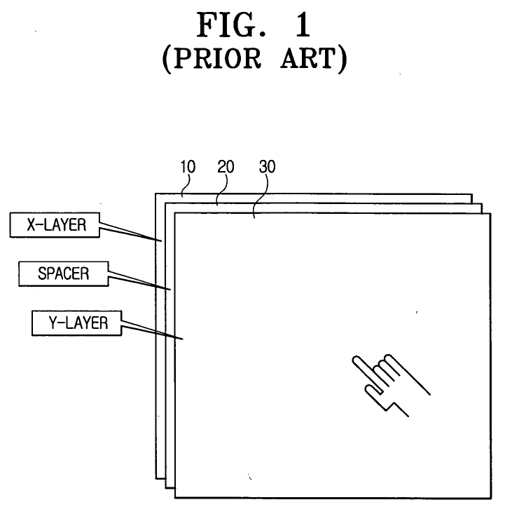

### DETAILED DESCRIPTION OF THE EXEMPLARY EMBODIMENTS

Certain embodiments of the present invention will be described in greater detail with reference to the accompanying drawings.

In the following description, same drawing reference numerals are used for the same elements even in different drawings. The matters defined in the description, such as a detailed construction and elements, are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

The user interface according to the present invention generates an input signal that corresponds to a user's instruction for moving a cursor on a screen of a display device, and outputs the input signal to the display device. If the user inclines the user interface having a built-in geomagnetic sensor in a direction in which the cursor is to move while viewing the screen of the display device, the user interface calculates new coordinate values of the cursor corresponding to the inclining state, and outputs the calculated new coordinate values of the cursor to the display device.

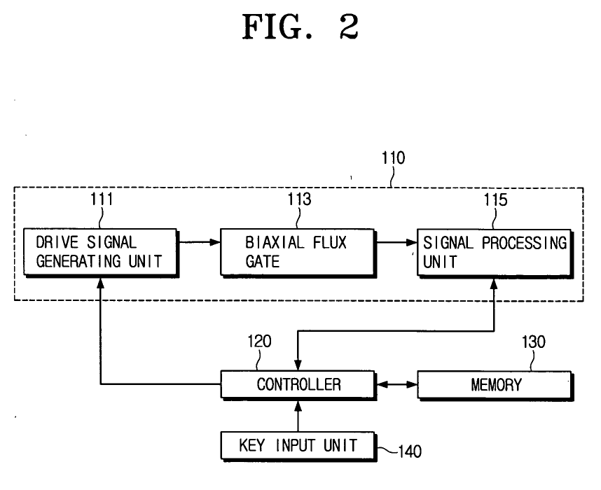

FIG. 2 is a block diagram illustrating the construction of a user interface using a geomagnetic sensor according to the present invention. Referring to FIG. 2, the user interface includes a geomagnetic sensor 110, a controller 120, a memory 130, and a key input unit 140.

The geomagnetic sensor 110 is generally built in a portable electronic appliance, and is used for various purposes such as providing of a compass function or map information that is displayed on a portable electronic appliance by measuring the geomagnetic field of a spot subject to observation and calculating the position of the spot.

In the embodiment of the present invention, a biaxial flux gate geomagnetic sensor is used. In comparison to other types of geomagnetic sensors, the biaxial flux gate geomagnetic sensor is highly sensitive, economical, and relatively small-sized. Also, the biaxial flux gate geomagnetic sensor has a low power consumption and superior long-term stability.

In the embodiment of the present invention, the biaxial flux gate geomagnetic sensor 110 is composed of a drive signal generating unit 111, a biaxial flux gate 113, and a signal processing unit 115.

The drive signal generating unit 111 is composed of a drive pulse generating circuit and a current amplifying circuit for driving coils. The drive pulse generating circuit generates a drive pulse signal for driving the biaxial flux gate, switches and selectively applies the generated drive pulse signal to the current amplifying circuit for driving coils. The current amplifying circuit for driving coils uses several amplifiers and inverters, and outputs a pulse signal and an inverted pulse signal which have phases opposite to each other with respect to the pulse signal outputted through the drive pulse generating circuit.

The biaxial flux gate 113 includes X-axis and Y-axis flux gates which are orthogonal with each other. The biaxial flux gate 113 is driven by the pulse signal and the inverted pulse signal transferred to the X-axis and Y-axis flux gates, respectively, and outputs detected signals corresponding to electromotive forces which are produced according to the driving of the biaxial flux gate 113. The X-Y flux gates 113 have two magnetic cores which are in a form of a tetragonal ring and installed in directions of X and Y axes, respectively. A drive coil and a detection coil are wound on each magnetic core. If drive pulse signals are applied to the drive coils, magnetic fields are generated on the X-axis and Y-axis flux gates, and the corresponding induction electromotive forces are detected through the detection coils.

The signal processing unit 115 includes a chopping circuit, a first amplifying circuit, a low-pass filter, a second amplifying circuit, and an analog-to-digital (A/D) converter. The electric signal detected through the biaxial flux gate 113 is chopped by a chopping circuit which has several controlled switches. The chopped electric signal is differentially amplified by the first amplifying circuit, filtered through the low-pass filter, and then finally amplified by the second amplifying circuit. The amplified signal is converted into a digital voltage value by the A/D converter.

The controller 120 monitors the A/D converter so that the A/D converter outputs the digital voltage value having a specified amplitude and adjusts the gain of the second amplifying circuit. It is preferable that the digital voltage value output from the A/D converter has an integer value having a level corresponding to the coordinates of the screen of the display device.

Before the geomagnetic sensor 110 is used as the input device for moving the cursor, a normalization process should be performed once in order for the geomagnetic sensor 110 to perform the compass function by calculating an azimuth angle from the output values of the geomagnetic sensor 110. Hereinafter, the normalization process will be explained.

The maximum value fx_max and the minimum value fx_min are obtained by monitoring the X-axis output value fx and the Y-axis output value fy of the geomagnetic sensor 110 as the horizontally positioned geomagnetic sensor 110 makes one revolution or more, and the obtained maximum and minimum values are stored in the memory 130 such as EEPROM. During a correction process using the maximum value fx_max and the minimum value fx_min, a value obtained by adding the maximum value fx_max and the minimum value fx_min and then dividing the added value by two, i.e., the average value of the two values, is defined as a bias value (fx_bias=(fx_max+fx_min)/2), and a value obtained by dividing the difference value between the two values by two is defined as a scale factor value (fx_scale=(fx_max−fx_min)/2). In order to normalize the signal of the geomagnetic sensor 110 to a value in the range of ±1, the bias value is subtracted from the present output value, and then the subtracted value is divided by the scale factor value. The normalized value is obtained with respect to each axis whenever signals are obtained from the flux gate geomagnetic sensor.

The normalized value is changed as the geomagnetic sensor is inclined. In order to effect the normalization even when the sensor is inclined, an inclination value should be considered. That is, the normalized value is multiplied by a cosine value of the inclination. Accordingly, if the sensing axis of the sensor coincides with the direction of inclination, the normalized value becomes the maximum value of ‘1’, while otherwise, the normalized value becomes the minimum value of ‘−1’.

After the normalization process is completed as described above, the initialization process of the user interface is performed.

Center coordinate values (cx, cy), which are obtained by dividing the width and the length of the screen of the display device to be used by two, are stored in the memory 130.

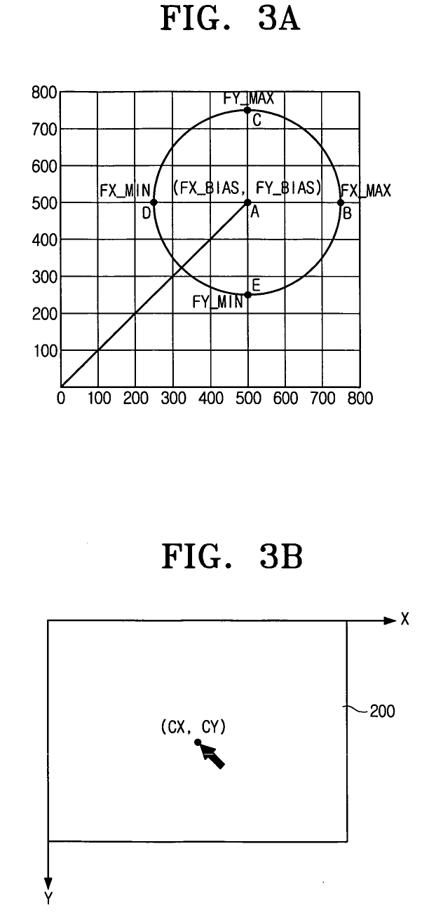

Then, the X-axis output value fx of a cosine waveform and the Y-axis output value fy of a sine waveform of the geomagnetic sensor 110 are obtained when the user interface makes one revolution in a horizontal state. FIG. 3A is a view illustrating an X-axis output value and a Y-axis output value obtained when the user interface is rotated in a horizontal state according to the present invention. Referring to FIG. 3A, the X-axis output value fx and the Y-axis output value are expressed as points on a circle the center of which is a point A, and points B, D, C and E indicate the maximum value fx_max of the X-axis output, the minimum value fx_min of the X-axis output, the maximum value fy_max of the Y-axis output, and the minimum value fy_min of the Y-axis output, respectively.

The values of the point A are the bias values (fx_bias=(fx_max+fx_min)/2, fy_bias=(fy_max+fy_min)/2) which are the average values of the maximum values (fx_max, fy_max) of the X-axis output and the Y-axis output and the minimum values (fx_min, fy_min) of the X-axis output and the Y-axis output. The controller 120 calculates the bias values from the maximum values and the minimum values of the digital output values outputted from the signal processing unit 115, and then stores the calculated values in memory 130.

FIG. 3B illustrates a screen 200 of a display device. The bias values (fx_bias, fy_bias) as calculated above are matched to the center coordinates (cx, cy) of the screen of the display device.

If the user intends to move the cursor to a desired position on the screen 200 of the display device as he/she is viewing the screen, he/she inclines the user interface in a direction in which the cursor is to be moved.

In accordance with the inclining direction and the inclining degree of the geomagnetic sensor 110, the output values of the geomagnetic sensor 110 are changed. The controller 120 updates the output values nx and ny stored in the memory 130 to the output values fx and fy of the geomagnetic sensor 110 changed in accordance with the inclining state of the geomagnetic sensor.

The controller 120 calculates the new coordinate values of the cursor using the following equation.

ti mx=cx+nx−fx_bias
my=cy+ny−fy_bias [Equation 1]

The cursor is displayed at the new coordinates (mx, my) in accordance with the user's desire. The new coordinates (mx, my) of the cursor are stored in the memory 130 to update the coordinates (omx, omy), and the new coordinates are then used when the previous cursor is deleted and the new cursor is displayed.

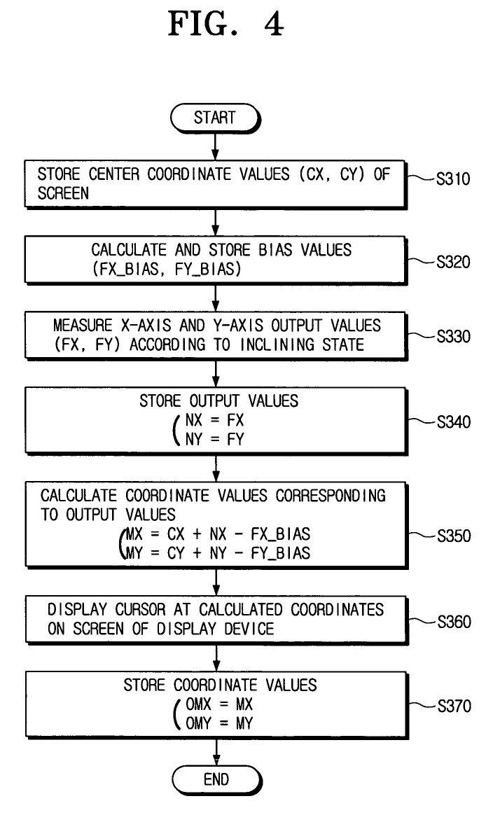

FIG. 4 is a flowchart illustrating a method of generating an input signal of a user interface using a geomagnetic sensor according to the present invention.

After the normalization process is performed, the controller 120 stores center coordinate values (cx, cy), which are obtained by dividing the width and the length of a screen by two, in the memory 130 (step S310).

Then, if the user makes one revolution of the user interface that includes the geomagnetic sensor 110 in a horizontal state, the geomagnetic sensor 110 senses the X-axis and Y-axis signals induced by the geomagnetic field, and outputs integer voltage values.

The bias values (fx_bias=(fx_max+fx_min)/2, fy_bias=(fy_max+fy_min)/2), which are the average values of the maximum values (fx_max, fy_max) of the X-axis output and the Y-axis output and the minimum values (fx_min, fy_min) of the X-axis output and the Y-axis output, are calculated, and then stored in the memory 130 (step S320).

If the user inclines the user interface in a certain direction in the state that steps S310 and S320 are completed, the geomagnetic sensor 110 sends the X-axis output value fx and the Y-axis output value fy, which correspond to the inclining direction and the inclining degree of the user interface, to the controller 120 (step S330). The output values nx and ny stored in the memory 130 are updated to the X-axis output value fx and the Y-axis output value fy (step S340).

The controller 120 reads out the center coordinate values (cx, cy), the bias values fx_bias and fy_bias, and the output values nx and ny of the geomagnetic sensor 110 from the memory 130, and calculates the new coordinate values (mx, my) of the cursor using the equation 1 (step S350). The calculated new coordinate values (mx, my) are sent to the display device, so that the previous cursor is erased, and the new cursor is displayed at the calculated coordinates (mx, my) of the screen (step S360). Also, the present coordinate values (omx, omy) stored in the memory 130 are updated to the calculated new coordinate values (mx, my) (step S370).

Meanwhile, after the cursor is moved by inclining the user interface in a desired direction, the user may manipulate buttons provided in the key input unit 140 to perform a click or double-click function.

As described above, the user interface according to the present invention has advantages over conventional interfaces. For example, when a user inclines the user interface including the geomagnetic sensor in a certain direction, the coordinates at which the cursor is displayed are calculated from the X-axis and Y-axis output values of the geomagnetic sensor in accordance with the inclining direction and the inclining degree, and accordingly the input signal corresponding to the user's instruction is generated. Consequently, the user interface according to the present invention can be applied to compact electronic appliances such as cellular phones, PDAs, etc., to provide diverse services such as games, screen control, etc.

The foregoing embodiment and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A user interface using a geomagnetic sensor which generates an input signal for moving a pointer to a certain position on a screen of a display device in accordance with a user's request, the user interface comprising:
a geomagnetic sensor for digitalizing and outputting voltage values of X and Y axes of the geomagnetic sensor, which are induced by a geomagnetic field and correspond to an inclining state of the user interface, with predetermined levels;
a memory for storing the output values of the geomagnetic sensor, present coordinates of the pointer, and center coordinates of the screen; and
a controller for controlling the output levels of the geomagnetic sensor, calculating new coordinates of the pointer corresponding to the inclining state using the output values of the X and Y axes, and outputting a signal corresponding to information about the new coordinates of the pointer to the display device.

2. The user interface as claimed in claim 1, wherein the output values of the geomagnetic sensor are integers.

3. The user interface as claimed in claim 2, wherein when the geomagnetic sensor is rotated in a horizontal state, the controller calculates bias values defined as average values of maximum values and minimum values of the output values of the X and Y axes, respectively, and stores the calculated bias values in the memory.

4. The user interface as claimed in claim 3, wherein the bias values correspond to the center coordinates of the screen.

5. The user interface as claimed in claim 4, wherein the new coordinates of the pointer are calculated using a following equation:
mx=cx 30 nx−fx_bias
my=cy+ny−fy_bias
wherein cx and cy denote the center coordinates (cx, cy) of the screen, nx and ny denote the output values of the X and Y axes of the geomagnetic sensor, and fx_bias and fy_bias denote the bias values.

6. The user interface as claimed in claim 1, wherein the controller outputs the signal corresponding to the information about the new coordinates of the pointer to the display device, and updates the present coordinates to the new coordinates.

7. The user interface as claimed in claim 1, wherein the geomagnetic sensor comprises:
a drive signal generating unit for generating a drive pulse signal and generating a voltage according to the drive pulse signal;
a biaxial flux gate for receiving the voltage and outputting the voltage values corresponding to analog signals for the X and Y axes in accordance with the geomagnetic field; and
a signal processing unit for amplifying the voltage values and converting the amplified voltage values into digital values.

8. A method of generating an input signal of a user interface using a geomagnetic sensor for controlling a position of a pointer on a screen of a display device in accordance with a user's request, the method comprising the steps of:
(a) storing center coordinates of the screen in a memory;
(b) rotating the user interface in a horizontal state, calculating bias values defined as average values of maximum values and minimum values of the output values of X and Y axes of the geomagnetic sensor, and storing the calculated bias values in the memory;
(c) measuring the output values of the X and Y axes corresponding to an inclining state of the user interface; and
(d) calculating new coordinates of the pointer corresponding to the inclining state of the user interface using the output values of the X and Y axes.

9. The method as claimed in claim 8, further comprising the step of (e) outputting a signal corresponding to information about the new coordinates of the pointer to the display device.

10. The method as claimed in claim 8, wherein the output values of the geomagnetic sensor are integers.

11. The method as claimed in claim 8, wherein the bias values correspond to the center coordinates of the screen.

12. The method as claimed in claim 11, wherein the new coordinates of the pointer are calculated using a following equation:
mx=cx+nx−fx_bias
my=cy+ny−fy_bias
wherein cx and cy denote the center coordinates (cx, cy) of the screen, nx and ny denote the output values of the X and Y axes of the geomagnetic sensor, and fx_bias and fy_bias denote the bias values.
